(19) United States
(12) Patent Application Publication
(10) Pub. No.: US 2026/0169855 A1
(43) Pub. Date: Jun. 18, 2026

(54) ADAPTIVE STICKY READ USING BFEA BINS

(71) Applicant: Micron Technology, Inc., Boise, ID (US)

(72) Inventors: Yuqi Zhu, Milpitas, CA (US); Ting Luo, Santa Clara, CA (US)

(21) Appl. No.: 18/980,808

(22) Filed: Dec. 13, 2024

(51) Int. Cl. G06F 11/10

(52) U.S. Cl. CPC G06F 11/1068; G06F 11/1004; G06F 11/1016

(57) ABSTRACT

A processing device enables a sticky read mode for a group of blocks of a memory device classified in a particular block family error avoidance (BFEA) bin among multiple BFEA bins. Based on the sticky read mode being enabled for the group of blocks, the processing device applies a sticky read offset to a default read voltage for the group of blocks. The sticky read offset is based on the particular BFEA bin in which the group of blocks is classified. The processing device performs one or more read operations on one or more blocks from the group of blocks using the default read voltage with the sticky read offset applied.

### TECHNICAL FIELD

Embodiments of the disclosure relate generally to memory sub-systems and, more specifically, to techniques for performing read operations using Block Family Error Avoidance (BFEA) Bin-dependent sticky read offsets.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some examples.

FIG. 2 is data flow diagrams illustrating interactions between components in the memory sub-system in performing read operations using BFEA Bin-dependent sticky read offsets, in accordance with some examples.

FIG. 3 includes two graphs that illustrate example applications of BFEA Bin-dependent sticky read offsets to default read voltages, in accordance with some examples.

FIG. 4 is a flow diagram illustrating an example method for performing read operations using BFEA Bin-dependent sticky read offsets, in accordance with some examples.

FIG. 5 is a block diagram of an example computer system in which embodiments of the present disclosure may operate.

### DETAILED DESCRIPTION

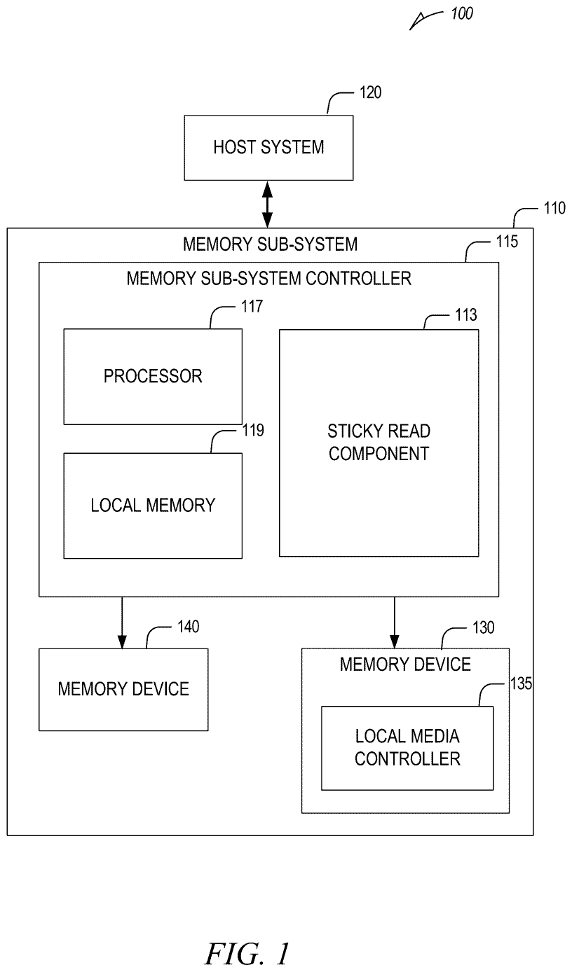

Aspects of the present disclosure are directed to an approach for performing read operations on a memory device in a memory sub-system using BFEA bin-dependent sticky read offsets. A memory sub-system can be a memory device (e.g., solid-state drive [SSD]), a memory module, or a combination of a memory device and memory module. Examples of memory devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. A memory sub-system controller typically receives commands or operations from the host system and converts the commands or operations into instructions or appropriate-commands to achieve the desired access to the memory components of the memory sub-system.

A memory device can be a non-volatile memory device. One example of a non-volatile memory device is a negative- and (NAND) memory device. A NAND memory device can include multiple NAND dies. Each die may include one or more planes, and each plane includes multiple blocks. Each block includes an array that includes pages (rows) and strings (columns). A string includes a plurality of memory cells connected in series. A memory cell (also referred to herein simply as a “cell”) is an electronic circuit that stores information. Depending on the cell type, a cell can store one or more bits of binary information and has various logic states that correlate to the number of bits being stored. The logic states can be represented by binary values, such as “0” and “1,” or combinations of such values.

Various memory access operations can be performed on the memory cells. Data can be written to, read from, and erased from memory cells. Memory cells can be grouped into a write unit, such as a page. For some types of memory devices, a page is the smallest write unit. A page size represents a particular number of cells of a page. Data can be written to a block, page-by-page. During write operations, data is programmed into a block of the memory device using a programming sequence that includes multiple passes in which programming pulses are applied to cells in the block. Over the multiple passes, the programming pulses configure the threshold voltages (Vt) of the cells in each page according to the value that the cells are intended to represent. As the programming sequence progresses, the voltage level of the programming pulses increase until a target voltage level for each cell is reached.

The Vt distribution of a memory cell can be divided into a number of regions based on the number of bits stored by the cell where each region corresponds to a value that can be represented by the cell. More specifically, each region corresponds to a read level, and each read level decodes into a multi-bit value. For example, a TLC NAND flash cell can be at one of eight charge levels (L0, L1, L2, L3, L4, L5, L6, or L7) and each charge level decodes into a 3-bit value that is stored in the flash cell (e.g., 111, 110, 100, 000, 010, 011, 001, and 101).

Managing read operations efficiently is crucial for maintaining optimal performance of memory devices. One of the key challenges in memory sub-systems is handling threshold voltage (Vt) variations due to various factors such as word line-to-word line (WL/WL) variations and block-to-block variations. These variations can lead to read errors and performance degradation if not properly addressed.

Various techniques are employed by memory sub-systems to mitigate the impact of Vt variations. One such technique is the use of read error handling (REH) mechanisms. When a default read operation fails due to inaccurate read voltages, REH is triggered to find a more accurate read voltage that allows for successful data retrieval. However, relying solely on REH can lead to increased latency and reduced read performance.

To improve upon the basic REH approach, many memory sub-systems implement a technique known as “sticky read”. The sticky read algorithm allows the system to remember and reuse previously successful read voltages for future read operations. This approach can significantly reduce the frequency of REH triggers and improve overall read performance.

In conventional implementations, sticky read typically employs a global offset that is applied uniformly across all blocks in the memory device. While this approach provides some benefits, it has limitations in addressing the varying characteristics of different blocks within the memory system.

Another important aspect of memory device management is tracking and compensating for Slow Charge Loss (SCL) of memory cells. SCL is a major degradation mechanism for data retention (DR). In particular, due to the effects of SCL, memory cells have their Vt distributions lose charge, with the highest Vt distributions typically losing charge faster than lower Vt distributions. SCL is usually a function of time and temperature, and can also be susceptible to other factors, such as cycling degradation (e.g., more Vt distribution shift for End of Life [EOL] blocks than for Beginning of Life [BOL] blocks). SCL usually causes a memory cell's Vt distribution to shift lower (e.g., causes the Vt distribution valley to shift lower) right after the memory cell is programmed.

Generally, to read data from a memory cell, one or more read level voltages are applied to the gate of a transistor (of the memory cell) to determine (e.g., sense) the value of the current threshold voltage (e.g., the voltage at which the transistor conducts current), and the current threshold voltage value can be decoded (e.g., mapped) to a data value (e.g., bit string) stored by the memory cell. To compensate for SCL-based shift when performing a read operation on a memory cell, an offset (or read level voltage offset) is usually applied to one or more read level voltages (also referred to herein as read levels) used to read data from the memory cell. Traditionally, the read level voltage offset applied to a memory cell is determined based on SCL tracking. Tracking SCL of memory cells is crucial to avoiding excessive latency impact, which can be caused by unnecessary error handling that results from incorrect read level placement (which can occur if a read level voltage offset applied to a read level voltage causes it to be placed without considering SCL effect on Vt distributions). Intrinsically, the effects of SCL on a memory cell hold strong dependence on a wordline (WL) group of the memory cell due to process variation (process variation that existed when the memory cell was manufactured) and asymmetric bitline (BL) cross-section at each WL. For instance, the cross-section can be larger at the top of the WL of each deck and yield smaller effective field, or the cross-section can be smaller at the bottom of the WL of each deck and yield stronger effective field. Accordingly, traditional methods for SCL tracking include performing periodic, proactive scans of blocks (comprising memory cells) and classify measured read level voltage offsets of scanned blocks into one of multiple predefined bins. Blocks with similar SCL characteristics can be grouped together in a bin to improve the management efficiency.

As an example, a block family error avoidance (BFEA) algorithm (one example of SCL tracking) can scan blocks to determine a shift of read level 7 (LVL7 or L7). The determined shift of read level 7 can be categorized into a specific bin (e.g., BFEA bin), read level voltage offsets for read levels 1 through 7 can be determined from a look-up table (LUT) (e.g., BFEA LUT) based on the specific bin (e.g., from a column of the LUT corresponding to the specific bin), and the determined read level voltage offsets can be used in a read operation (e.g., host reads) for one or more of those blocks. For example, if the shift of read level 7 of a memory cell is −23, characterized by BFEA scan, the BFEA algorithm can determine (e.g., identify) a bin (e.g., BFEA bin) that is associated with the shift of −23 (e.g., bin 5 based on example Table 1, provided below), can determine read level voltage offsets for read levels 1 through 7 from the LUT (e.g., read level voltage offsets of bin 5's column of example Table 2, provided below) based on the determined bin (e.g., column associated with the bin), and can use the one or more determined read level voltage offsets in connection with a read operation for the memory cell.

TABLE 1

| | BIN | | | | | | |
|---|---|---|---|---|---|---|---|
| | 1 | 2 | 3 | 4 | 5 | 6 | 7 |
| Shift range | [−3, −8] | [−9, −13] | [−14, −16] | [−17, −21] | [−22, −26] | [−27, −32] | [−33, ->] |

TABLE 2

| | BIN | | | | | | |
|---|---|---|---|---|---|---|---|
| | 1 | 2 | 3 | 4 | 5 | 6 | 7 |
| LVL1 | | | | | | | |
| LVL2 | −1 | −2 | −2 | −3 | −4 | −4 | −5 |
| LVL3 | −2 | −4 | −4 | −6 | −8 | −8 | −9 |
| LVL4 | −2 | −4 | −6 | −6 | −8 | −11 | −13 |
| LVL5 | −3 | −6 | −7 | −9 | −12 | −14 | −17 |
| LVL6 | −4 | −8 | −10 | −12 | −16 | −20 | −23 |
| LVL7 | −6 | −12 | −15 | −18 | −24 | −30 | −36 |

Aspects of the present disclosure address the above and other issues with a memory sub-system that utilizes sticky read offsets that are dependent on BFEA bin classifications. In an example, a memory sub-system controller detects a failed read operation on a block in a memory device of the memory sub-system that utilizes a default read voltage. In response to the failed read operation, the memory sub-system controller performs read error handling to identify a passing read voltage that results in a successful read operation. The memory sub-system controller uses the passing read voltage in subsequent read operations, and once a predetermined number of successful read operations are performed using the passing read voltage, the memory sub-system controller sets the passing voltage as the default voltage and enables a sticky read mode for a BFEA bin group corresponding to the block. Based on sticky read being enabled for the block, a sticky read component determines an appropriate sticky read offset for the BFEA bin group. The memory sub-system controller monitors read operations using the applied sticky read offsets and disables sticky read mode for the BFEA bin group if a predetermined number of failed read operations occurs using the sticky read offset. With sticky read mode being disabled, the memory sub-system controller performs read operations using the default voltage without the sticky read offset applied.

By utilizing BFEA bin-dependent sticky read offsets, the system can more accurately adjust read voltages based on the specific characteristics of different block groups within the memory device. This granular approach allows for better handling of variations in threshold voltage distributions caused by factors such as slow charge loss, which can affect different BFEA bin groups differently. The implementation of bin-specific sticky read offsets increases the coverage and accuracy of sticky read operations across blocks at different bins, preventing performance loss when sticky read operations transition between blocks in different bins. Importantly, this improved accuracy, and coverage is achieved with minimal additional memory overhead, as the system only needs to store offsets for each BFEA bin group rather than for each individual block. This efficient use of memory resources allows for enhanced read performance without significantly impacting the memory sub-system's storage capacity or complexity.

FIG. 1 illustrates an example computing environment 100 that includes a memory sub-system 110, in accordance with some embodiments of the present disclosure.

The memory sub-system 110 can include media, such as one or more volatile memory devices (e.g., memory device 140), one or more non-volatile memory devices (e.g., memory device 130), or a combination of such.

A memory sub-system 110 can be a memory device, a memory module, or a hybrid of a memory device and memory module. Examples of a memory device include an SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

An example of non-volatile memory devices (e.g., memory device 130) includes a NAND type flash memory. Each of the memory devices 130 can include one or more arrays of memory cells such as single level cells (SLCs), multi-level cells (MLCs) (e.g., triple level cells [TLCs], or quad-level cells [QLCs]). In some embodiments, a particular memory component can include an SLC portion, and an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The memory sub-system controller 115 can communicate with the memory devices 130 to perform operations such as reading data, writing data, or erasing data at the memory devices 130 and at other such operations. The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130.

The memory sub-system 110 also includes a sticky read component 113 that is responsible for determining BFEA Bin-dependent sticky read offsets for use in read operations. The memory sub-system controller 115 enables and disables sticky read mode for BFEA bin groups based on the success or failure of read operations. When sticky read mode is enabled for a BFEA bin group, the sticky read component 113 determines the appropriate sticky read offset for that bin group (e.g., by accessing a look-up table that maps BFEA bins to sticky read offsets). The memory sub-system controller 115 monitors the performance of read operations using the applied sticky read offsets and disables sticky read mode for a BFEA bin group if a predetermined number of failed read operations occur using the sticky read offset.

In some embodiments, the memory sub-system controller 115 includes at least a portion of the sticky read component 113. For example, the memory sub-system controller 115 can include a processor 117 (processing device) configured to execute instructions stored in local memory 119 (e.g., firmware) for performing the operations described herein. In some embodiments, the sticky read component 113 is part of the host system 120, an application, or an operating system. Further details regarding the sticky read component 113 are discussed below.

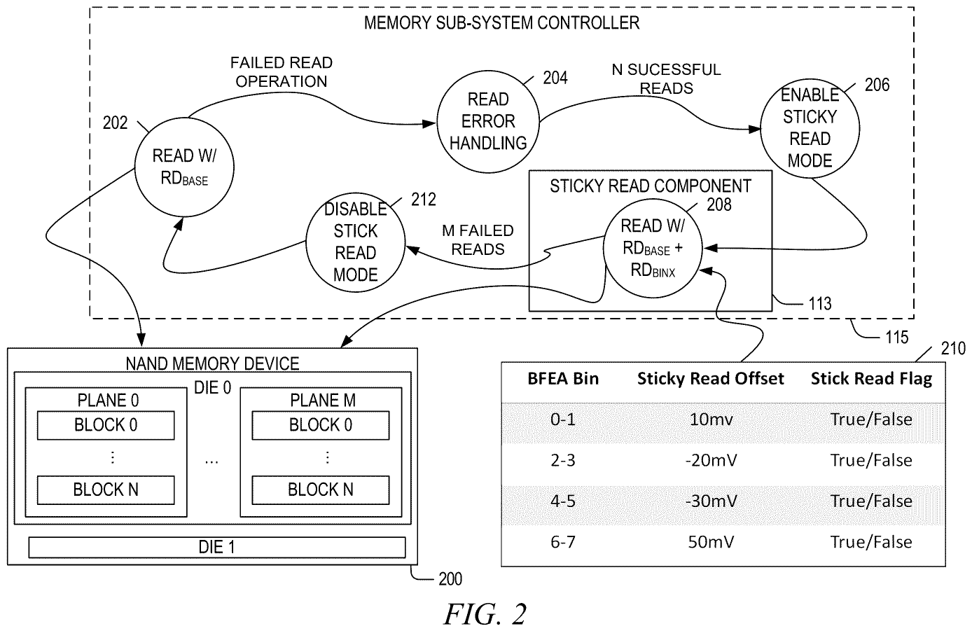

FIG. 2 is a data flow diagram illustrating interactions between components in the memory sub-system in performing a conditional delay of block folding in a memory device 200 at boot-up, in accordance with some examples. In the example illustrated in FIG. 2, the memory device 200 is an example memory device 130 in the example form of a NAND memory device.

The memory device 200 includes multiple NAND dies. Each die may include one or more planes, and each plane includes multiple blocks such as block₀-block₈ illustrated in FIG. 2. Each block includes a two- or three-dimensional array that includes pages (rows) and strings (columns). A string includes a plurality of memory cells connected in series. Each memory cell is used to represent one or more bit values. For example, a single NAND flash cell includes a transistor that stores an electric charge on a memory layer that is isolated by oxide insulating layers above and below. Within each cell, data is stored as the threshold voltage of the transistor. SLC NAND, for example, can store one bit per cell. Other types of memory cells, such as MLCs, TLCs, QLCs, and PLCs, can store multiple bits per cell. In this example, the NAND memory includes an SLC portion that includes multiple SLCs and a QLC portion that includes multiple QLCs.

As noted above, each NAND cell stores data in the form of the threshold voltage (V_{T}) of the transistor. The range of threshold voltages of a memory cell can be divided into a number of regions based on the number of bits stored by the cell where each region corresponds to a value that can be represented by the cell. More specifically, each region corresponds to a read voltage level (also referred to simply as “read level”) and each read voltage level decodes into a multi-bit value. For example, a TLC NAND flash cell can be at one of eight read levels (L0, L1, L2, L3, L4, L5, L6, or L7) and each read level decodes into a 3-bit value that is stored in the flash cell (e.g., 111, 110, 100, 000, 010, 011, 001, and 101).

Each block of the memory device 200 is classified into a bin from among multiple predefined bins based on read level shifts of the blocks (e.g., a shift of read level 7). Each bin has a corresponding read level voltage offset to apply to blocks in the bin. The bin classifications for each block of the memory device 200 are determined based on a BFEA scan, which in some examples, may be performed prior to power down of the memory sub-system 110. During the BFEA scan, the blocks are scanned to determine the shift of read level 7 (LVL7 or L7) and the determined shift of read level 7 of each block is categorized into a specific bin (e.g., BFEA bin) among the multiple predefined bins. Blocks are grouped into BFEA bin groups based on the BFEA bin to which they are classified. A BFEA bin group comprises all blocks assigned to a specific BFEA bin group. For example, a first BFEA bin group comprises all blocks assigned to BFEA bin 0, a second BFEA bin group comprises all blocks assigned to BFEA bin 1, a third BFEA bin group comprises all blocks assigned to BFEA bin 2, and so forth.

As shown, the memory sub-system controller 115, at operation 202, performs read operations with a default read voltage (RDBASE) on a block of the memory device 200. Upon detecting a failed read operation, the memory sub-system controller 115 performs read error handling (REH), at operation 204, to identify a passing read voltage that results in a successful read operation on the block. The passing read voltage is then used for subsequent read operations on the block.

When a predetermined number (N) of successful read operations have been performed using the passing read voltage, the memory sub-system controller 115 sets the passing read voltage as the default read voltage (RDBASE) and enables sticky read mode for the BFEA bin group of the block, at operation 206. Based on the sticky read mode being enabled for the BFEA bin group, the sticky read component 113 applies a BFEA bin-dependent sticky read offset (RDBINX) to the default read voltage (RDBASE) for subsequent read operations on blocks in that bin group (operation 208). This offset is specific to the BFEA bin of the block, allowing for more accurate read voltages based on the block's characteristics. Consistent with this example, the sticky read component 113 determines the BFEA bin-dependent sticky read offset (RDBINX) by accessing look-up table 210 (e.g., from local memory 119). The look-up table 210 comprises a mapping between BFEA bins and sticky read offsets. For example, as shown, the sticky read offset for BFEA bins 0 and 1 is 10 mV while the sticky read offset for BFEA bins 2 and 3 is −20 mV.

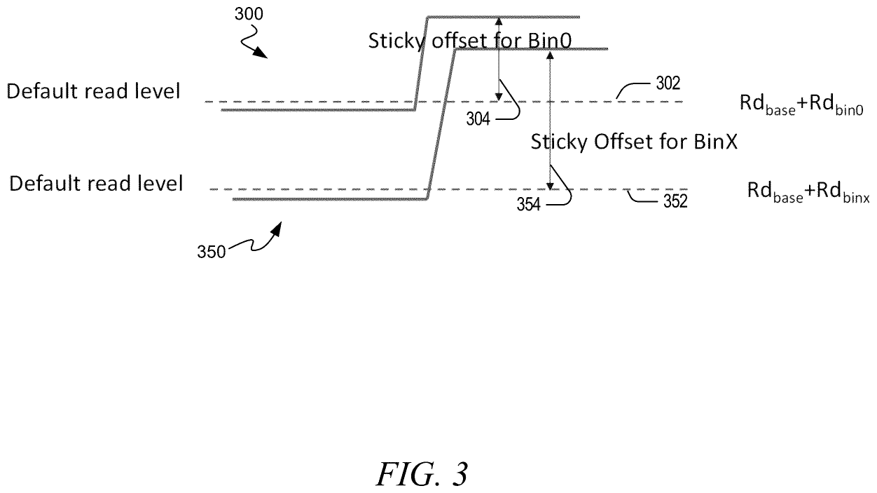

FIG. 3 illustrates example applications of BFEA Bin-dependent sticky read offsets to default read voltages. More specifically, graph 300 illustrates the application of a sticky read offset 304 (RD_{BIN0}) to a default read voltage 302 (RDBASE) for a first BFEA bin (Bin0), while graph 350 shows the application of a sticky read offset 354 (RDBINX) to a default read voltage 352 (RDBASE) for a second BFEA bin (BinX). The graphs 300 and 350 demonstrate how the sticky read offsets vary depending on the BFEA bin classification of the blocks. For example, the offset for Bin0 (RD_{BIN0}) is smaller compared to the offset for BinX (RDBINX).

With reference back to FIG. 2, the sticky read component 113 monitors read operations using the sticky read offset applied to the default voltage, and if a predetermined number (M) of failed read operations occur using the sticky read offset, the sticky read component 113 disables the sticky read mode for that BFEA bin group, at operation 212. When the sticky read mode is disabled, the memory sub-system controller 115 reverts to using the default read voltage (RDBASE) without the sticky read offset for subsequent read operations on blocks in that bin group.

This process of enabling and disabling sticky read mode, applying bin-dependent sticky read offsets, and reverting to default read voltages allows the memory sub-system 110 to dynamically adjust read voltages based on the characteristics of different blocks and their BFEA bin classifications, thereby improving read performance and accuracy.

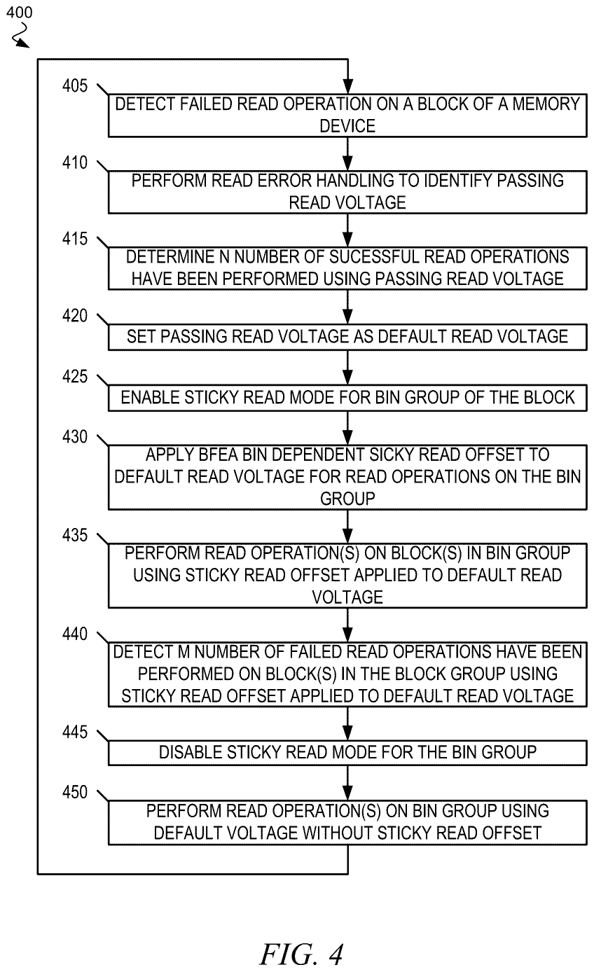

FIG. 4 is a flow diagram illustrating an example method 400 for performing read operations using BFEA Bin-dependent sticky read offsets, in accordance with some examples. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 400 is performed by the sticky read component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment; other process flows are possible.

To set the context of method 400, the memory device includes a set of blocks, and each block in the set of blocks is classified into a bin from among multiple predefined bins based on read level shifts of the set of blocks (e.g., a shift of read level 7). The bin classifications for each block in the set of blocks are determined based on a BFEA scan, which in some examples, may be performed prior to power down of the memory sub-system. Blocks classified within a BFEA bin are grouped together in a BFEA bin group. That is, a BFEA bin group includes a group of blocks classified into the same BFEA bin.

At operation 405, the processing device detects a failed read operation performed on a block from the set of blocks of the memory device using a default read voltage. In some examples, the processing device detects the failed read operation based on a failed read status received from the memory device.

At operation 410, the processing device performs read error handling based on detecting the failed read operation performed on the block. In performing the read error handling, the processing device identifies a passing read voltage that results in a successful read operation on the block of the memory device. To identify the passing read voltage, the processing device may iteratively attempt read operations with different read voltages (e.g., with incremental increases to the read voltage at each iteration) until the passing voltage that results in a successful read operation is identified.

The passing read voltage is used to read data from the block in subsequent read operations. At operation 415, the processing device determines that a predetermined number, N, of successful read operations using the passing read voltage have been performed on the block of the memory device. Based on determining that the passing read voltage has been used in the predetermined number of successful read operations, the processing device sets the passing voltage as the default voltage (operation 420) and enables a sticky read mode for the BFEA bin group of the block (operation 425).

Based on the stick read mode being enabled for the BFEA bin group, the processing device applies a BFEA bin dependent sticky read offset to the default voltage for the bin group (operation 430). That is, the processing device identifies a sticky read offset for the bin group based on the BFEA bin and applies the sticky read offset to the default voltage. In some examples, the processing device access a look-up table that includes a mapping between BFEA bins and sticky read offsets and determines the sticky read offset for the bin group from the look-up table.

The processing device performs one or more read operations for one or more blocks in the bin group using the sticky read offset applied to the default read voltage, at operation 435. At operation 440, the processing device detects a predetermined number, M, of failed read operations on at least one block of the bin group using the sticky read offset applied to the default read voltage. In some examples, the predetermined number N and the predetermined number M are the same, while in other examples, N and M are different numbers.

Based on detecting the predetermined number, M, of failed read attempts using the sticky read offset applied to the default voltage, the processing device disables sticky read mode for the bin group, at operation 445. Based on sticky mode being disabled, the processing device uses the default read voltage for read operations on blocks in the bin group (operation 450).

Described implementations of the subject matter can include one or more features, alone or in combination, as illustrated below by way of example.

Example 1. A memory sub-system comprising: a memory device comprising a set of blocks; a processing device, operatively coupled with the memory device, to perform operations comprising: enabling a sticky read mode for a group of blocks of the memory device classified in a particular block family error avoidance (BFEA) bin among multiple BFEA bins; based on the sticky read mode being enabled for the group of blocks, applying a sticky read offset to a default read voltage for the group of blocks, the sticky read offset being based on the particular BFEA bin in which the group of blocks is classified; and performing one or more read operations on one or more blocks from the group of blocks using the default read voltage with the sticky read offset applied.

Example 2. The memory sub-system of Example 1, wherein the operations comprise: detecting a predetermined number of failed read operations on at least one block of the group of blocks using the default read voltage with the sticky read offset applied; and based on detecting the predetermined number of failed read operations, disabling the sticky read mode for the group of blocks of the memory device.

Example 3. The memory sub-system of any one or more of Examples 1 or 2, wherein the operations comprise using the default read voltage without the sticky read offset applied to perform read operations on blocks in the group of blocks based on the sticky read mode for the group of blocks being disabled.

Example 4. The memory sub-system of any one or more of Examples 1-3, wherein: the group of blocks is a first group of blocks classified in a first BFEA bin; the sticky read offset is a first sticky read offset; the default read voltage is a first default read voltage; the operations comprise: enabling a sticky read mode for a second group of blocks of the memory device classified in a second BFEA bin; based on the sticky read mode being enabled for the second group of blocks, applying a second sticky read offset to a second default read voltage for the second group of blocks based on the second group of blocks being classified in the second BFEA bin; and performing at least one read operation on at least one block from the second group of blocks using the second default read voltage with the second sticky read offset applied.

Example 5. The memory sub-system of any one or more of Examples 1-4, wherein the operations comprise determining the sticky read offset for the group of blocks based on the particular BFEA bin in which the group of blocks is classified.

Example 6. The memory sub-system of any one or more of Examples 1-5, wherein the determining of the sticky read offset for the group of blocks comprises accessing a look-up table comprising a mapping between BFEA bin groups and sticky read offsets.

Example 7. The memory sub-system of any one or more of Examples 1-6, wherein the operations comprise: detecting a failed read operation performed on a block from the group of blocks of the memory device; based on detecting the failed read operation, performing read error handling, the performing of read error handling comprising identifying a passing read voltage that results in a successful read operation on the block of the memory device; and determining a predetermined number of successful read operations using the passing read voltage have been performed on the block of the memory device, wherein the enabling of the sticky read mode for the group of blocks is based on based on determining that the predetermined number of successful read operations using the passing read voltage have been performed on the block of the memory device.

Example 8. The memory sub-system of any one or more of Examples 1-7, wherein the operations comprise setting the passing read voltage as the default read voltage for the group of blocks based on determining that the predetermined number of successful read operations using the passing read voltage have been performed on the block of the memory device.

Example 9. A method comprising: enabling, by a processing device, a sticky read mode for a group of blocks of a memory device classified in a particular block family error avoidance (BFEA) bin among multiple BFEA bins; based on the sticky read mode being enabled for the group of blocks, applying, by the processing device, sticky read offset to a default read voltage for the group of blocks, the sticky read offset being based on the particular BFEA bin in which the group of blocks is classified; and performing, by the processing device, one or more read operations on one or more blocks from the group of blocks using the default read voltage with the sticky read offset applied.

Example 10. The method of Example 9, comprising: detecting a predetermined number of failed read operations on at least one block of the group of blocks using the default read voltage with the sticky read offset applied; and based on detecting the predetermined number of failed read operations, disabling the sticky read mode for the group of blocks of the memory device.

Example 11. The method of any one or more of Examples 9 or 10, comprising using the default read voltage without the sticky read offset applied to perform read operations on blocks in the group of blocks based on the sticky read mode for the group of blocks being disabled.

Example 12. The method of any one or more of Examples 9-11, wherein: the group of blocks is a first group of blocks classified in a first BFEA bin; the sticky read offset is a first sticky read offset; the default read voltage is a first default read voltage; the method comprises: enabling a sticky read mode for a second group of blocks of the memory device classified in a second BFEA bin; based on the sticky read mode being enabled for the second group of blocks, applying a second sticky read offset to a second default read voltage for the second group of blocks based on the second group of blocks being classified in the second BFEA bin; and performing at least one read operation on at least one block from the second group of blocks using the second default read voltage with the second sticky read offset applied.

Example 13. The method of any one or more of Examples 9-12, comprising determining the sticky read offset for the group of blocks based on the particular BFEA bin in which the group of blocks is classified.

Example 14. The method of any one or more of Examples 9-13, wherein the determining of the sticky read offset for the group of blocks comprises accessing a look-up table comprising a mapping between BFEA bin groups and sticky read offsets.

Example 15. The method of any one or more of Examples 9-14, comprising: detecting a failed read operation performed on a block from the group of blocks of the memory device; based on detecting the failed read operation, performing read error handling, the performing of read error handling comprising identifying a passing read voltage that results in a successful read operation on the block of the memory device; and determining a predetermined number of successful read operations using the passing read voltage have been performed on the block of the memory device, wherein the enabling of the sticky read mode for the group of blocks is based on based on determining that the predetermined number of successful read operations using the passing read voltage have been performed on the block of the memory device.

Example 16. The method of any one or more of Examples 9-15, comprising setting the passing read voltage as the default read voltage for the group of blocks based on determining that the predetermined number of successful read operations using the passing read voltage have been performed on the block of the memory device.

Example 17. A computer-readable storage medium comprising instructions that, when executed by a processing device, configure the processing device to perform operations comprising: enabling a sticky read mode for a group of blocks of a memory device classified in a particular block family error avoidance (BFEA) bin among multiple BFEA bins; based on the sticky read mode being enabled for the group of blocks, applying sticky read offset to a default read voltage for the group of blocks, the sticky read offset being based on the particular BFEA bin in which the group of blocks is classified; and performing one or more read operations on one or more blocks from the group of blocks using the default read voltage with the sticky read offset applied.

Example 18. The computer-readable storage medium of Example 17, wherein the operations comprise: detecting a predetermined number of failed read operations on at least one block of the group of blocks using the default read voltage with the sticky read offset applied; and based on detecting the predetermined number of failed read operations, disabling the sticky read mode for the group of blocks of the memory device.

Example 19. The computer-readable storage medium of any one or more of Examples 17 or 18, comprising using the default read voltage without the sticky read offset applied to perform read operations on blocks in the group of blocks based on the sticky read mode for the group of blocks being disabled.

Example 20. The computer-readable storage medium of any one or more of Examples 17 or 18, wherein: the group of blocks is a first group of blocks classified in a first BFEA bin; the sticky read offset is a first sticky read offset; the default read voltage is a first default read voltage; the operations comprise: enabling a sticky read mode for a second group of blocks of the memory device classified in a second BFEA bin; based on the sticky read mode being enabled for the second group of blocks, applying a second sticky read offset to a second default read voltage for the second group of blocks based on the second group of blocks being classified in the second BFEA bin; and performing at least one read operation on at least one block from the second group of blocks using the second default read voltage with the second sticky read offset applied.

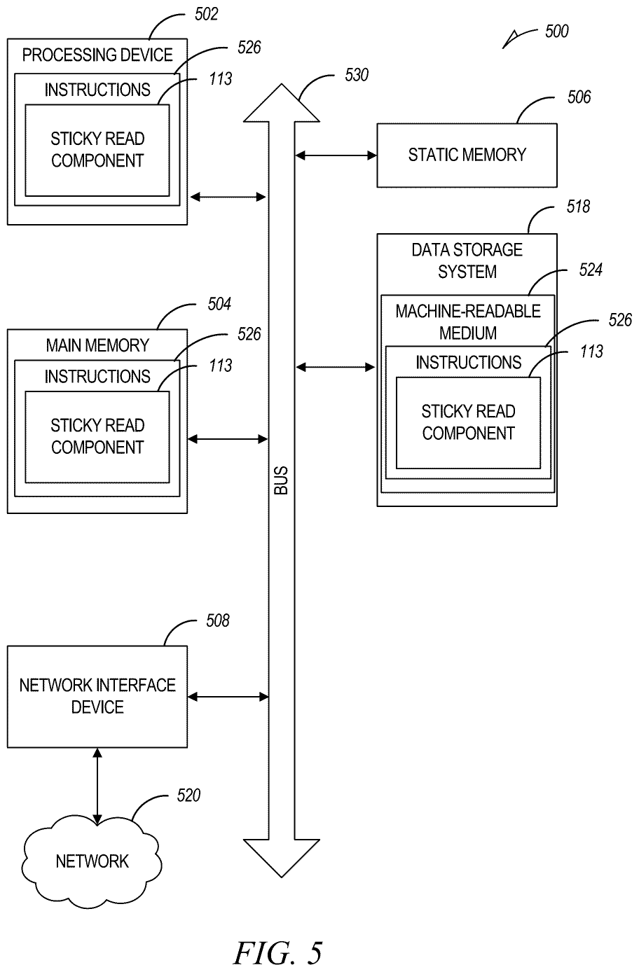

FIG. 5 illustrates an example machine in the form of a computer system within which a set of instructions can be executed for causing the machine to perform any one or more of the methodologies discussed herein. FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the sticky read component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an ASIC, a FPGA, a digital signal processor (DSP), network processor, or the like. The processing device 502 is configured to execute instructions 526 for performing the operations and steps discussed herein. The computer system 500 can further include a network interface device 508 to communicate over a network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a sticky read component (e.g., the sticky read component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A memory sub-system comprising:
a memory device comprising a set of blocks;
a processing device, operatively coupled with the memory device, to perform operations comprising:
enabling a sticky read mode for a group of blocks of the memory device classified in a particular block family error avoidance (BFEA) bin among multiple BFEA bins;
based on the sticky read mode being enabled for the group of blocks, applying a sticky read offset to a default read voltage for the group of blocks, the sticky read offset being based on the particular BFEA bin in which the group of blocks is classified; and
performing one or more read operations on one or more blocks from the group of blocks using the default read voltage with the sticky read offset applied.

2. The memory sub-system of claim 1, wherein the operations comprise:
detecting a predetermined number of failed read operations on at least one block of the group of blocks using the default read voltage with the sticky read offset applied; and
based on detecting the predetermined number of failed read operations, disabling the sticky read mode for the group of blocks of the memory device.

3. The memory sub-system of claim 2, wherein the operations comprise using the default read voltage without the sticky read offset applied to perform read operations on blocks in the group of blocks based on the sticky read mode for the group of blocks being disabled.

4. The memory sub-system of claim 1, wherein:
the group of blocks is a first group of blocks classified in a first BFEA bin;
the sticky read offset is a first sticky read offset;
the default read voltage is a first default read voltage;
the operations comprise:
enabling a sticky read mode for a second group of blocks of the memory device classified in a second BFEA bin;
based on the sticky read mode being enabled for the second group of blocks, applying a second sticky read offset to a second default read voltage for the second group of blocks based on the second group of blocks being classified in the second BFEA bin; and
performing at least one read operation on at least one block from the second group of blocks using the second default read voltage with the second sticky read offset applied.

5. The memory sub-system of claim 1, wherein the operations comprise determining the sticky read offset for the group of blocks based on the particular BFEA bin in which the group of blocks is classified.

6. The memory sub-system of claim 5, wherein the determining of the sticky read offset for the group of blocks comprises accessing a look-up table comprising a mapping between BFEA bin groups and sticky read offsets.

7. The memory sub-system of claim 1, wherein the operations comprise:
detecting a failed read operation performed on a block from the group of blocks of the memory device;
based on detecting the failed read operation, performing read error handling, the performing of read error handling comprising identifying a passing read voltage that results in a successful read operation on the block of the memory device; and
determining a predetermined number of successful read operations using the passing read voltage have been performed on the block of the memory device, wherein the enabling of the sticky read mode for the group of blocks is based on based on determining that the predetermined number of successful read operations using the passing read voltage have been performed on the block of the memory device.

8. The memory sub-system of claim 7, wherein the operations comprise setting the passing read voltage as the default read voltage for the group of blocks based on determining that the predetermined number of successful read operations using the passing read voltage have been performed on the block of the memory device.

9. A method comprising:
enabling, by a processing device, a sticky read mode for a group of blocks of a memory device classified in a particular block family error avoidance (BFEA) bin among multiple BFEA bins;
based on the sticky read mode being enabled for the group of blocks, applying, by the processing device, sticky read offset to a default read voltage for the group of blocks, the sticky read offset being based on the particular BFEA bin in which the group of blocks is classified; and
performing, by the processing device, one or more read operations on one or more blocks from the group of blocks using the default read voltage with the sticky read offset applied.

10. The method of claim 9, comprising:
detecting a predetermined number of failed read operations on at least one block of the group of blocks using the default read voltage with the sticky read offset applied; and
based on detecting the predetermined number of failed read operations, disabling the sticky read mode for the group of blocks of the memory device.

11. The method of claim 10, comprising using the default read voltage without the sticky read offset applied to perform read operations on blocks in the group of blocks based on the sticky read mode for the group of blocks being disabled.

12. The method of claim 9, wherein:
the group of blocks is a first group of blocks classified in a first BFEA bin;
the sticky read offset is a first sticky read offset;
the default read voltage is a first default read voltage;
the method comprises:
enabling a sticky read mode for a second group of blocks of the memory device classified in a second BFEA bin;
based on the sticky read mode being enabled for the second group of blocks, applying a second sticky read offset to a second default read voltage for the second group of blocks based on the second group of blocks being classified in the second BFEA bin; and
performing at least one read operation on at least one block from the second group of blocks using the second default read voltage with the second sticky read offset applied.

13. The method of claim 9, comprising determining the sticky read offset for the group of blocks based on the particular BFEA bin in which the group of blocks is classified.

14. The method of claim 13, wherein the determining of the sticky read offset for the group of blocks comprises accessing a look-up table comprising a mapping between BFEA bin groups and sticky read offsets.

15. The method of claim 9, comprising:
detecting a failed read operation performed on a block from the group of blocks of the memory device;
based on detecting the failed read operation, performing read error handling, the performing of read error handling comprising identifying a passing read voltage that results in a successful read operation on the block of the memory device; and
determining a predetermined number of successful read operations using the passing read voltage have been performed on the block of the memory device, wherein the enabling of the sticky read mode for the group of blocks is based on based on determining that the predetermined number of successful read operations using the passing read voltage have been performed on the block of the memory device.

16. The method of claim 15, comprising setting the passing read voltage as the default read voltage for the group of blocks based on determining that the predetermined number of successful read operations using the passing read voltage have been performed on the block of the memory device.

17. A computer-readable storage medium comprising instructions that, when executed by a processing device, configure the processing device to perform operations comprising:
enabling a sticky read mode for a group of blocks of a memory device classified in a particular block family error avoidance (BFEA) bin among multiple BFEA bins;
based on the sticky read mode being enabled for the group of blocks, applying sticky read offset to a default read voltage for the group of blocks, the sticky read offset being based on the particular BFEA bin in which the group of blocks is classified; and
performing one or more read operations on one or more blocks from the group of blocks using the default read voltage with the sticky read offset applied.

18. The computer-readable storage medium of claim 17, wherein the operations comprise:
detecting a predetermined number of failed read operations on at least one block of the group of blocks using the default read voltage with the sticky read offset applied; and
based on detecting the predetermined number of failed read operations, disabling the sticky read mode for the group of blocks of the memory device.

19. The computer-readable storage medium of claim 18, comprising using the default read voltage without the sticky read offset applied to perform read operations on blocks in the group of blocks based on the sticky read mode for the group of blocks being disabled.

20. The computer-readable storage medium of claim 18, wherein:
the group of blocks is a first group of blocks classified in a first BFEA bin;
the sticky read offset is a first sticky read offset;
the default read voltage is a first default read voltage;
the operations comprise:
enabling a sticky read mode for a second group of blocks of the memory device classified in a second BFEA bin;
based on the sticky read mode being enabled for the second group of blocks, applying a second sticky read offset to a second default read voltage for the second group of blocks based on the second group of blocks being classified in the second BFEA bin; and
performing at least one read operation on at least one block from the second group of blocks using the second default read voltage with the second sticky read offset applied.
